(19) United States
(12) Patent Application Publication
(10) Pub. No.: US 2026/0178064 A1
(43) Pub. Date: Jun. 25, 2026

(54) VOLTAGE REGULATOR CIRCUIT

(71) Applicant: Renesas Design (UK) Limited, Bourne End (GB)

(72) Inventors: Keisuke KADOWAKI, Tokyo (JP); Davide BIANCHI, Swindon (GB)

(73) Assignee: Renesas Design (UK) Limited, Bourne End (GB)

(21) Appl. No.: 19/000,928

(22) Filed: Dec. 24, 2024

(51) Int. Cl. G05F 1/46; G05F 1/56; G05F 1/62

(52) U.S. Cl. CPC G05F 1/468; G05F 1/461; G05F 1/562; G05F 1/62

(57) ABSTRACT

A method for operating a voltage regulator circuit for converting an input voltage into an output voltage comprising an input port for receiving an input voltage, an output port for providing an output voltage, an output voltage reference circuit configured to output a reference voltage, an overshoot detection device, an inductive device, and an overshoot reduction control circuit comprising a peak comparator device, the method comprising: in response to detecting, by the overshoot detection device, that the output voltage exceeds a first threshold, generating a first control signal configured to turn on an overshoot reduction function configured to reduce the output voltage; determining when to end the overshoot reduction function by: detecting, using the peak comparator device if the output voltage crosses a second threshold and; if the output voltage is detected to have crossed the second threshold, generating a second control signal configured to control the overshoot protection function to end.

The present disclosure relates to a voltage regulator circuit configured to provide a mechanism for ending an overshoot reduction function.

### BACKGROUND

Recently, processors (such as MCUs and GPUs) require high current which may be driven by DC-DC buck converters. The buck converter generates a low voltage (for example, 0.6V) for the power supply of the processor. The processor needs pulse-driven high current which reaches upwards of 40A repeatedly in a short time. In this situation, the voltage output of the buck converter may show overshoot when the processor stops consuming high current, something which happens commonly and suddenly in processors. Therefore, it is known to provide overshoot protection which aims to reduce the voltage overshoot and, if overshoot successful, suppresses the level of overshoot.

However, when the processor still consumes an amount of current (for example, 10A) after overshoot, overshoot reduction may be too strong. This is because overshoot protection is commonly only terminated when an inductor current of 0A is reached.

As mentioned above, point-of-load power converters must supply output current loads that experience high slew rates. This is to allow for the maximum operating efficiency of MCUs and GPUs. When the processors are in use, they are put into sleep-mode very rapidly. Thus, it is common for an output load to immediately fall from 30-40A to 0A in a very short period.

As shown in the line labelled “Vout” in FIG. 1, this causes a voltage over-shoot of the output voltage. Unfortunately, with output voltage rails going to deep sub 1V (~0.5V), the voltage over-shoot causes the output voltage to exceed the output voltage regulation envelope. When the output load current rapidly drops to 0A, the output voltage over-shoot causes a rise in Vout.

To address Vout over-shoot, it is known to implement overshoot reduction control commonly referred to as body-braking. This is illustrated in FIG. 2.

To initiate body-brake, typically an over-voltage threshold is implemented. Vout triggering this threshold indicates that the output load current has suddenly decreased with respect to the voltage regulator’s output current. Once body-brake has been enabled, the voltage across the inductor increases with respect to the value forced by the controller’s regulation loop (as seen in FIG. 1), causing the inductor current to decrease more rapidly. The increase of the inductor current negative slope directly lowers the rise of Vout and accelerates the recovery. This is shown by the line labelled 210. The initiation of body-brake is typically initiated when Vout exceeds the over-voltage threshold.

Also shown by FIG. 2, body-brake is typically terminated when the inductor current reaches 0A. This occurs at the “ZC” point as indicated on the graph. Although existing body-brake functions are effective when the output current suddenly drops to 0A, it is also a common situation that the output load drops from a high operating current to an intermediate output current. In this case, existing methods are not helpful. For example, if the output current drops from 40A to 10A, the body-brake function would not be terminated in good time because the inductor current does not reach 0A. In this case, the body-brake will overcompensate and result in over-shoot and under-shoot of the output voltage. This is illustrated in FIG. 3.

As FIG. 3 shows, body-brake is initiated when Vout triggers the over-voltage threshold. However, body-brake is terminated when the inductor current reaches 0A even though the output current is not at 0A (in this case, Iout=10A). This creates an over correction of the inductor current and creates a voltage under-shoot of Vout.

### SUMMARY

According to a first aspect of the disclosure, there is provided a method for operating a voltage regulator circuit for converting an input voltage into an output voltage comprising an input port for receiving an input voltage, an output port for providing an output voltage, an output voltage reference circuit configured to output a reference voltage, an overshoot detection device, an inductive device, and an overshoot reduction control circuit comprising a peak comparator device, the method comprising: in response to detecting, by the overshoot detection device, that the output voltage exceeds a first threshold, generating a first control signal configured to turn on an overshoot reduction function configured to reduce the output voltage; determining when to end the overshoot reduction function by: detecting, using the peak comparator device if the output voltage crosses a second threshold and; if the output voltage is detected to have crossed the second threshold, generating a second control signal configured to control the overshoot protection function to end.

Optionally, the second threshold corresponds to a value of the output voltage at which a rate of change of the output voltage is zero or negative.

Optionally, the first threshold is a voltage value that when exceeded by the output voltage indicates that the output voltage is greater than a target regulation voltage of the voltage regulator circuit.

Optionally, ending the overshoot reduction function comprises: comparing, using the peak comparator device, the reference voltage and a voltage output by a peak hold circuit of the overshoot reduction control circuit; and if the voltage output by the peak hold circuit decreases below the voltage of the reference circuit, generating the second control signal.

Optionally, ending the overshoot reduction function comprises: comparing, using the peak comparator device, an adjusted output voltage with a voltage output by a peak hold circuit of the overshoot reduction control circuit; and if the adjusted output voltage decreases below the voltage output by the peak hold circuit, generating the second control signal; wherein the adjusted output voltage is a combination of the output voltage and an offset voltage provided by a voltage offset element.

Optionally, the second control signal is a combination of a third control signal and a fourth control signal; wherein the third control signal is indicative of a difference between the reference voltage and the voltage output by the peak hold circuit; and wherein the fourth control signal is the voltage output by the peak hold circuit, wherein the voltage output by the peak hold circuit is indicative of a difference between the output voltage and the voltage across the capacitive device.

Optionally, the overshoot reduction function comprises: lowering an increase in output voltage; and/or maintaining a current amplitude for a period of time.

Optionally, lowering the increase of the output voltage comprises: increasing a voltage across an inductive device of the voltage regulator circuit such that a current of the inductive device is decreased.

Optionally, determining when to end the overshoot reduction function further comprises: detecting if a current across the inductive device or a low-side switch of the voltage regulator circuit reaches a third threshold; and if so, ending the overshoot reduction function.

Optionally, the third threshold is a value of zero.

According to a set aspect of the disclosure, there is provided a voltage regulator circuit for converting an input voltage into an output voltage, the voltage regulator circuit comprising: an input port for receiving an input voltage; an output port for providing an output voltage; a reference circuit; an overshoot comparator device; an overshoot reduction control circuit comprising a peak comparator device and a peak hold circuit, wherein the overshoot reduction control circuit is configured to: generate, in response to detecting, by the overshoot detection device, that the output voltage exceeds a first threshold, a first control signal configured to turn on an overshoot reduction function configured to reduce the output voltage; determine when to end the overshoot reduction function by: detecting, using the peak comparator device, if the output voltage crosses a second threshold and; if the output voltage is detected to have crossed the second threshold, generating a second control signal configured to control the overshoot reduction function to end.

an inductive device; and

Optionally, the peak hold circuit comprises an amplifier device, and is configured to maintain a constant current amplitude for the voltage regulator circuit when the overshoot reduction function is triggered; wherein the amplifier device is configured to receive a positive input from the output voltage and a negative input from the overshoot comparator device; and wherein the peak comparator device is configured to receive a positive input from the reference circuit and a negative input from the amplifier device.

Optionally, the peak hold circuit further comprises: a transistor device coupled with a first resistor, wherein the transistor device is configured to remove current sink capability and to realize peak hold circuit with a capacitive device; a capacitive device; a first resistor configured to maintain a voltage across the capacitive device when the output voltage is not detected to have exceeded the first threshold.

Optionally, ending the overshoot reduction function comprises: comparing, using the peak comparator device, a voltage of the reference circuit to a voltage across the capacitive device of the peak hold circuit; and if the voltage output by the peak hold circuit decreases below the reference voltage, generating the second control signal.

Optionally, ending the overshoot reduction function comprises: comparing, using the peak comparator device, an adjusted output voltage with a voltage output by the peak hold circuit; and if the adjusted output voltage decreases below the voltage output by the peak hold circuit, generating the second control signal; wherein the adjusted output voltage is a combination of the output voltage and an offset voltage provided by a voltage offset element of the overshoot reduction control circuit.

Optionally, the second control signal is a combination of a third signal and a fourth signal; wherein the third signal is indicative of a difference between the reference voltage and the voltage output by the peak hold circuit; and wherein the fourth signal is the voltage output by the peak hold circuit, wherein the voltage output by the peak hold circuit is indicative of a difference between the output voltage and the voltage across the capacitive device.

Optionally, the second control signal causes the overshoot reduction circuit to turn off a low-side switch to end the overshoot reduction function.

Optionally, the first control signal causes the overshoot reduction circuit to: turn off the first resistor, removing a current sink capability provided by the first resistor, wherein the current sink capability is configured to keep a peak voltage of the capacitive device of the peak hold circuit at a first voltage; maintain the first voltage and, using the peak comparator device, determine when the voltage output by the peak hold circuit meets a fourth threshold.

Optionally, the fourth threshold represents a point at which the voltage output by the peak hold circuit decreases below the reference voltage.

Optionally, the overshoot reduction circuit comprises: a peak comparator device configured to detect if the output voltage meets the second threshold; and a high-pass filter configured to detect a rate of change of the output voltage, wherein detecting the rate of change comprises detecting whether the output voltage is increasing, decreasing, or constant; wherein, if the rate of change of the output voltage is zero or negative, the second control signal is generated.

### BRIEF DESCRIPTION OF THE DRAWINGS

The disclosure is described in further detail below by way of example and with reference to the accompanying drawings, in which:

FIG. 1 is an example of a graph representing a voltage overshoot according to the prior art;

FIG. 2 is an example of a graph representing a bodybrake function according to the prior art;

FIG. 3 is an example of a graph representing a bodybrake function according to the prior art;

FIG. 4 is a block diagram representing an overshoot protection circuit;

FIG. 5 is an example of a graph representing a bodybrake function according to the current disclosure;

FIG. 6 is a flowchart representing a method of operating a voltage regulator circuit;

FIG. 7 is a circuit diagram of an overshoot protection circuit according to a first example;

FIG. 8 is a circuit diagram of an overshoot protection circuit according to a second example; and

FIG. 9 is a circuit diagram of an overshoot protection circuit according to a third example.

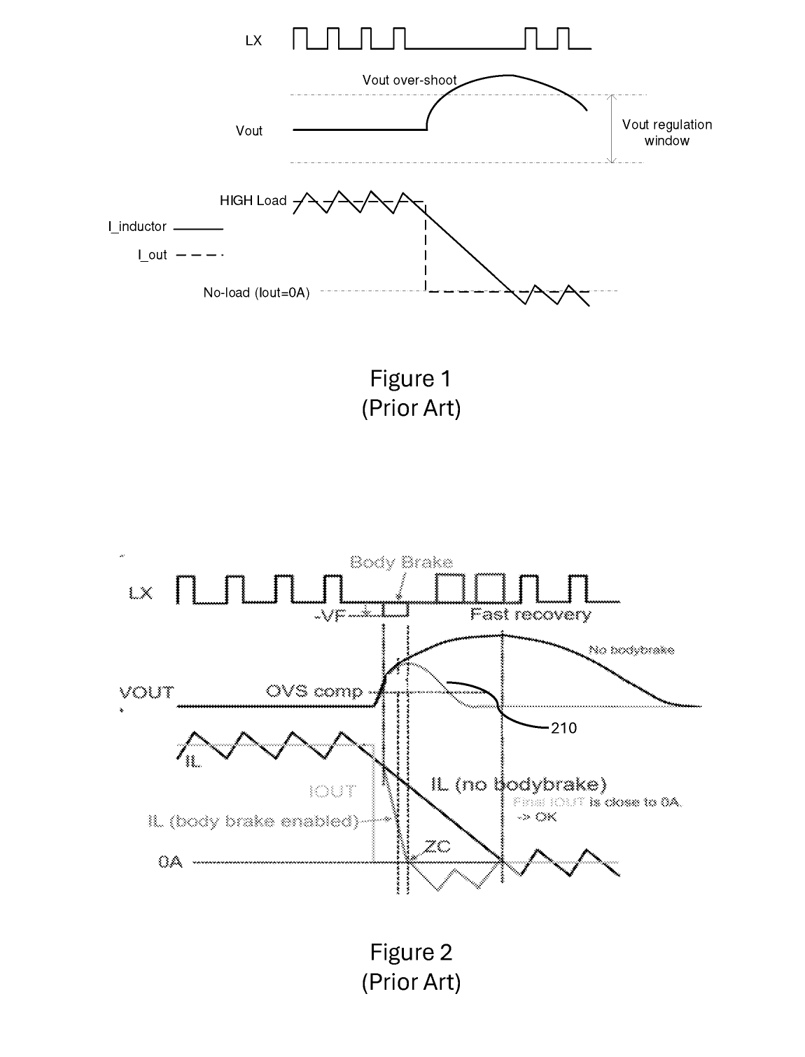

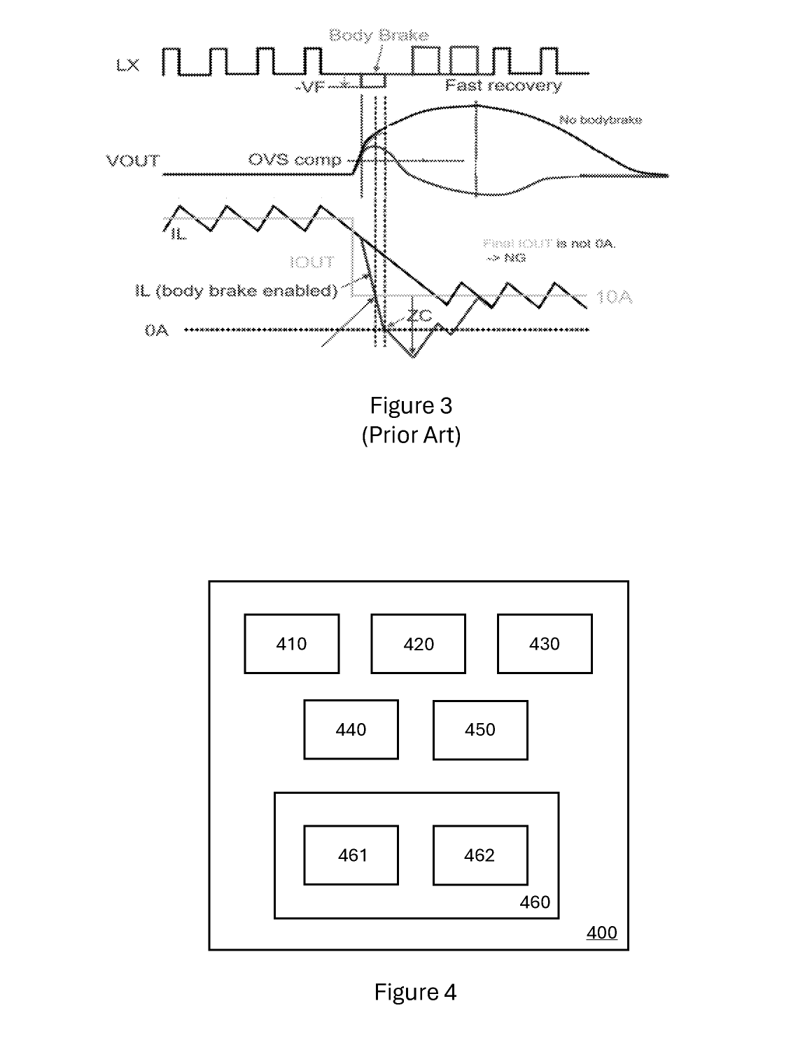

### DETAILED DESCRIPTION

The current disclosure relates to a novel termination trigger for an overshoot reduction function (conventionally known as a bodybrake function). The disclosed termination trigger is well suited to reduce undershoot of the output voltage following an initial overshoot, and applies to scenarios both where the output current drops to 0A as well as where the output current drops to an intermediate operating point. Thus, instead of terminating the overshoot reduction function based on a current in an inductive device, the current disclosure relates to a method of terminating the overshoot reduction function based on an output voltage. This allows the operation of the overshoot reduction function to be adaptive.

In the current disclosure, the term “coupled” refers to an electronic connection between two components.

In the current disclosure, the voltage regulator circuits described may be part of a device such as a CPU or GPU.

In the current disclosure, the term “bodybrake” or “overshoot reduction function” or “overshoot reduction control” refers to any process which might be used to reduce output voltage during an overshoot event.

FIG. 4 is a block diagram representing a voltage regulator circuit 400 according to the current disclosure. The voltage regulator circuit 400 comprises an input port 410 for receiving an input voltage; an output port 420 for providing an output voltage; an output voltage reference circuit 430 (for example, a digital-to-analog converter (DAC) circuit) configured to output a reference voltage; an overshoot detection device 440; an inductive device 450 (for example, an inductor or any other suitable device); and an overshoot reduction control circuit 460 comprising a peak comparator device 461 and a peak hold circuit 462.

The overshoot detection device 440 may be a part of the voltage regulator circuit 400 that is configured to detect when a voltage overshoot is happening. The overshoot detection device 440 may comprise a comparator device that is configured to detect when the output voltage of the voltage regulator circuit 400 has exceeded a first threshold by comparing a reference voltage output by the output voltage reference circuit 430 and the output voltage. The comparator device is configured to detect when the output voltage increases to a value that is indicative of the output load current suddenly decreasing with respect to an output current of the voltage regulator circuit.

The peak comparator device 461 is a comparator device that is configured to compare the reference voltage with an output voltage of the peak hold circuit 462. The peak comparator device 462 allows the overshoot reduction control circuit 460 to monitor the output voltage and determine when to terminate the overshoot reduction function. Thus, when the output voltage reaches a second threshold, this is detected by the peak comparator device 461 and the overshoot reduction function can be terminated. The peak comparator device 461 may, for example, be a voltage comparator.

The peak hold circuit 462 is a circuit that is configured to effectively “store” a voltage value when overshoot is detected, providing a “snapshot” of the output voltage that may be used by the peak comparator device 461 to compare with the reference voltage to determine when to terminate the overshoot reduction function.

The peak comparator device 461 and the peak hold circuit 462 may together form at least part of the overshoot reduction control circuit 460 and may be coupled.

It should be understood that the components of the voltage regulator circuit 400 may be coupled in a variety of ways.

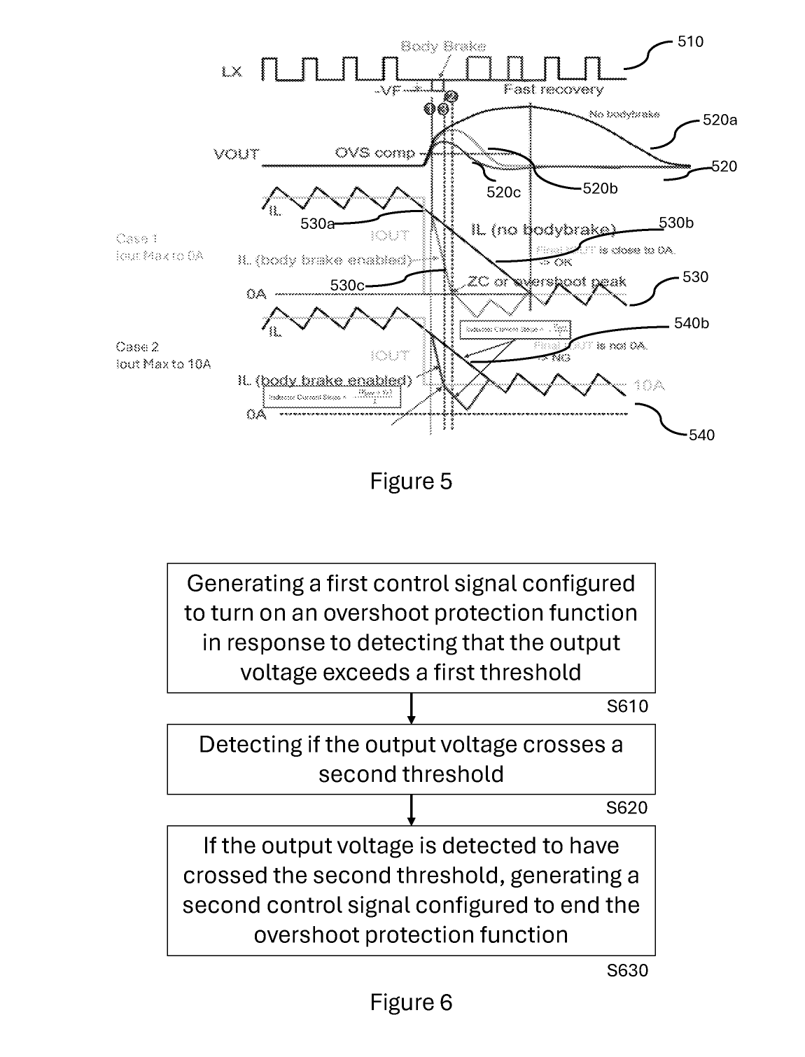

The operative effect of the voltage regulator circuit 400 is shown in FIG. 5, which is a diagram of various graphs illustrating the behaviour of output voltage and current of an inductive device when the overshoot reduction function is implemented. FIG. 5 provides two scenarios; a first scenario in which an output load current drops to 0A, and a second scenario in which the output load current drops to 10A.

The first line of the graph, labelled 510, shows an operating signal during operation of the voltage regulator circuit 400. Initially, normal operation can be seen, with the circuit turning on and off repeatedly. Then, when the device that the voltage regulator circuit 400 is part of is suddenly put to sleep (which may be part of normal operation for a device such as a GPU), the signal remains off until the bodybrake function has happened and normal operation resumes.

The effect of this can be seen in the second part of the graph 520 which shows the output voltage of the voltage regulator circuit 400. The output voltage begins at a low value (for example, a common operating voltage might be 0.6V or the like) and, when the inductor current drops, the output voltage begins to increase, or overshoot. At this point, when no bodybrake at all is applied, it can be seen that the voltage overshoot is uncontrolled, causing the voltage regulator circuit to output a large voltage (in comparison to usual operating conditions) which may cause damage to the device. This is shown by line 520a.

As shown by line 520b, when bodybrake according to the prior art is applied, the voltage overshoot is reduced. In comparison, as shown by line 520c, when the overshoot reduction control circuit 460 is used, the voltage overshoot is reduced even further, reducing both the peak voltage that is reached in the overshoot, as well as the time period that the voltage overshoot is happening over. This is because the voltage overshoot is detected, bodybrake is triggered, and the overshoot reduction control circuit 460 allows the bodybrake to be terminated adaptively.

The third section of FIG. 5, 530, represents a current of the inductive device 450 (herein known as the “inductor current”) in the case that the output current drops to 0A.

Initially, normal operation can be seen, with the inductor current pulsing regularly and repeatedly between values such that an average operating value of the inductor current is represented by line 530a. When the device is suddenly put to sleep, the inductor current drops swiftly to an average of 0A. As the inductor current begins to decrease, the voltage overshoot is caused, beginning at point 1. As shown by line 530b, when no bodybrake is implemented, the current drops steadily and unimpeded. In contrast, when bodybrake is implemented, the voltage across the inductive device 450 is increased, causing the inductor current to decrease much faster, reaching 0A in a shorter time. In both cases, when the inductor current reaches 0A, the bodybrake function is terminated (this is point 2 in the case that the bodybrake is implemented).

The fourth section of FIG. 5, 540, represents a current of the inductive device 450 (herein known as the “inductor current”) in the case that the output current drops to 10A.

Initially, normal operation can be seen, with the inductor current pulsing regularly and repeatedly. When the device is suddenly put to sleep, the inductor current drops swiftly to an average of 10A. As the inductor current begins to decrease, the voltage overshoot is caused, beginning at point 1. As shown by line 540b, when no bodybrake is implemented, the current drops steadily and unimpeded. In contrast, when bodybrake is implemented, the current decreases much faster, reaching 10A in a shorter time. In both cases, when the inductor current reaches 10A, the bodybrake function is terminated (this is point 3 in the case that the bodybrake is implemented).

It should be understood that FIG. 5 is merely exemplary, and does not represent actual values of operation. It has been provided to illustrate operating cases for a voltage regulator circuit according to the current disclosure.

The process for terminating the bodybrake adaptively is described by reference to FIG. 6, which is a flowchart illustrating a method for implementing an overshoot reduction function for a voltage regulator circuit such as the voltage regulator circuit discussed by reference to FIG. 4.

In step S610, a first control signal is generated in response to detecting that the output voltage exceeds a first threshold, wherein the first control signal is configured to turn on an overshoot reduction function. The overshoot reduction function is configured to reduce the output voltage. The overshoot reduction function may be implemented in the same way as discussed by reference to FIGS. 4 and 5.

The first threshold may correspond to a voltage value that when exceeded by the output voltage, indicates that the output voltage is greater than a target regulation voltage of the voltage regulator circuit 400..

That is, the first threshold may correspond to a voltage value that indicates that the output voltage is higher than the target voltage the voltage regulator circuit 400 is trying to regulate at. This will occur when the output current drops suddenly (for example, faster than the inductor current can follow), and the mismatch in the currents causes the voltage to rise.

In other words, the first threshold is an output voltage value that, when exceeded, causes the overshoot reduction function, or bodybrake function, to be turned on.

The overshoot reduction function may comprise lowering an increase in the output voltage of the voltage regulator circuit 400 and maintaining a current amplitude of the output load current for a period of time. Lowering the increase in the output voltage may comprise increasing a voltage across the inductive device 450 in order to decrease the inductor current.

Next, it is determined when to end the overshoot reduction function. This is described in steps S620 and S630.

In step S620, it is detected (or determined, calculated, or identified) if the output voltage crosses a second threshold. The detection is performed using the peak comparator device 461.

The second threshold may correspond to a value of the output voltage at which a rate of change of the output voltage is zero or negative. That is, referring back to FIG. 5, the second threshold may correspond to a value of the output voltage representing the peak of the overshoot (a maximum value of the overshoot, or a value where the rate of change of the output voltage is zero) or a value after the peak, on the downward slope of the output voltage (a value of the output voltage where the rate of change of the output voltage is negative, or the output voltage is decreasing).

In step S630, a second control signal is generated if the output voltage is detected to have crossed the second threshold. The second control signal is configured to control the overshoot reduction function to end.

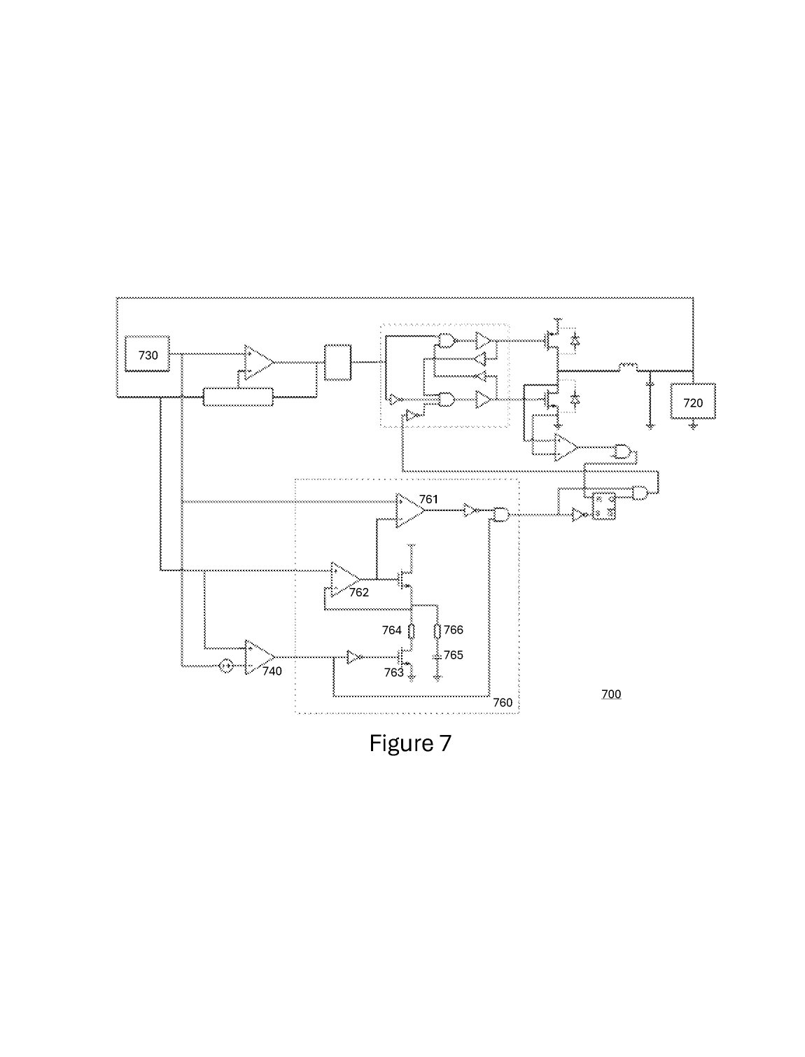

The second control signal may be a combination of a third control signal and a fourth control signal. The third control signal may be a signal generated by the peak comparator device 461 and may be indicative of a difference between the reference voltage and the voltage output by the peak hold circuit 462. The fourth control signal may be the voltage output by the peak hold circuit 462. The voltage output by the peak hold circuit 462 may be indicative of a difference between the output voltage and a voltage held by the peak hold circuit 462 (as is described in more detail with respect to FIG. 7).

Controlling the overshoot reduction function to end may comprise reducing the voltage across the inductive device 450 back to a level consistent with normal operation of the voltage regulator circuit 400. This allows the inductor current to increase back to a normal operating level, as illustrated by FIG. 5.

Ending the overshoot reduction function may comprise: comparing, using the peak comparator device 461, the reference voltage with a voltage output by the peak hold circuit 462 of the overshoot reduction control circuit 460 and, if the voltage output by the peak hold circuit 462 decreases below the voltage of the reference circuit, generating the second control signal.

Alternatively, ending the overshoot reduction function may comprise: comparing, using the peak comparator device 461, an adjusted output voltage with a voltage output by a peak hold circuit 462; and if the adjusted output voltage decreases below the voltage output by the peak hold circuit 462, generating the second control signal, wherein the adjusted output voltage is a combination of the output voltage and an offset voltage provided by a voltage offset element.

The voltage offset element may be a device that is used to provide an offset to a voltage that is input to the voltage offset element. The offset may be a set amount that is predetermined.

Additionally, the determination of when to end the overshoot reduction function may comprise detecting if a current across the inductive device or a low-side switch of the power conversion circuit (which experiences the same current as the inductive device) reaches a third threshold. If so, the overshoot reduction function may be ended. The third threshold may be a value of zero. That is, in addition to detecting whether the output voltage has reached or passed a peak value, it may be detected whether a current across the inductive device has reached zero (or functionally zero; for instance, a very low value).

FIG. 7 is a circuit diagram representing a voltage regulator circuit 800 such as the voltage regulator circuit 400 illustrated in FIG. 4.

The voltage regulator circuit 700 comprises an input port for receiving an input voltage; an output port 720 for providing an output voltage; a reference circuit 730 for providing a reference voltage; an overshoot comparator device 740; an inductive device; and an overshoot reduction control circuit 760 comprising a peak comparator device 761 and a peak hold circuit 762, wherein the overshoot reduction control circuit is configured to carry out the method described by reference to FIG. 6.

The peak comparator device 761 may be configured to receive a positive input from the reference circuit 730 and a negative input from the amplifier device of the peak hold circuit 762.

The peak hold circuit 762 may comprise an amplifier device and may be configured to maintain a constant current amplitude for the voltage regulator circuit 700 when the overshoot reduction function is triggered. The amplifier device may be configured to receive a positive input from the output voltage and a negative input from the overshoot comparator device 740.

The peak hold circuit 762 may additionally comprise a transistor device 763 (for example, a transistor or any other suitable device), a capacitive device 765 (for example, a capacitor or any other suitable charge-storing device), and a first resistor 764 coupled to the transistor device 763. Additionally, the capacitive device 765 may be coupled to a second resistor 766.

The transistor device 763 may be configured to remove current sink capability and to realize the peak hold circuit 762 by switchably connecting it with the capacitive device 765.

The first resistor 764 may be configured to maintain a voltage across the capacitive device 765 when the output voltage is not detected to have exceeded the first threshold (that is, the first resistor allows the capacitive device 765 to maintain a voltage before the overshoot begins and the overshoot reduction function is triggered). The voltage across the capacitive device 765 is configured to follow the voltage output by the peak hold circuit 762 as long as the first resistor 764 is effective. As such, when the overshoot reduction function is triggered, the transistor device may be used to turn the first resistor 764 off, allowing the voltage across the capacitive device 765 to effectively “store” the voltage at the point that the overshoot reduction function is triggered (there is no current sink for the output of the peak hold circuit), providing a voltage for the peak comparator device 761 to compare against.

In more detail, ending the overshoot reduction function may comprise comparing, using the peak comparator device 761, a voltage of the reference circuit to the voltage output by the peak hold circuit 762 (which is based on the voltage across the capacitive device). If the voltage output by the peak hold circuit 762 decreases below the reference voltage, the second control signal may be generated.

The second control signal may cause a low-side switch of the voltage regulator circuit 700 to switch off, thus ending the overshoot reduction function.

The first signal, generated in response to detecting, by the overshoot comparator device 740, that the output voltage exceeds a first threshold may cause the overshoot reduction circuit 760 to turn off the first resistor, removing a current sink capability provided by the first resistor, maintain the first voltage and, using the peak comparator device 761, determine when the voltage output by the peak hold circuit meets a fourth threshold. The fourth threshold may represent a point at which the voltage output by the peak hold circuit 762 decreases below the reference voltage.

The current sink capability of the first resistor may be configured to keep a peak voltage of the capacitive device of the peak hold circuit 762 at a first voltage.

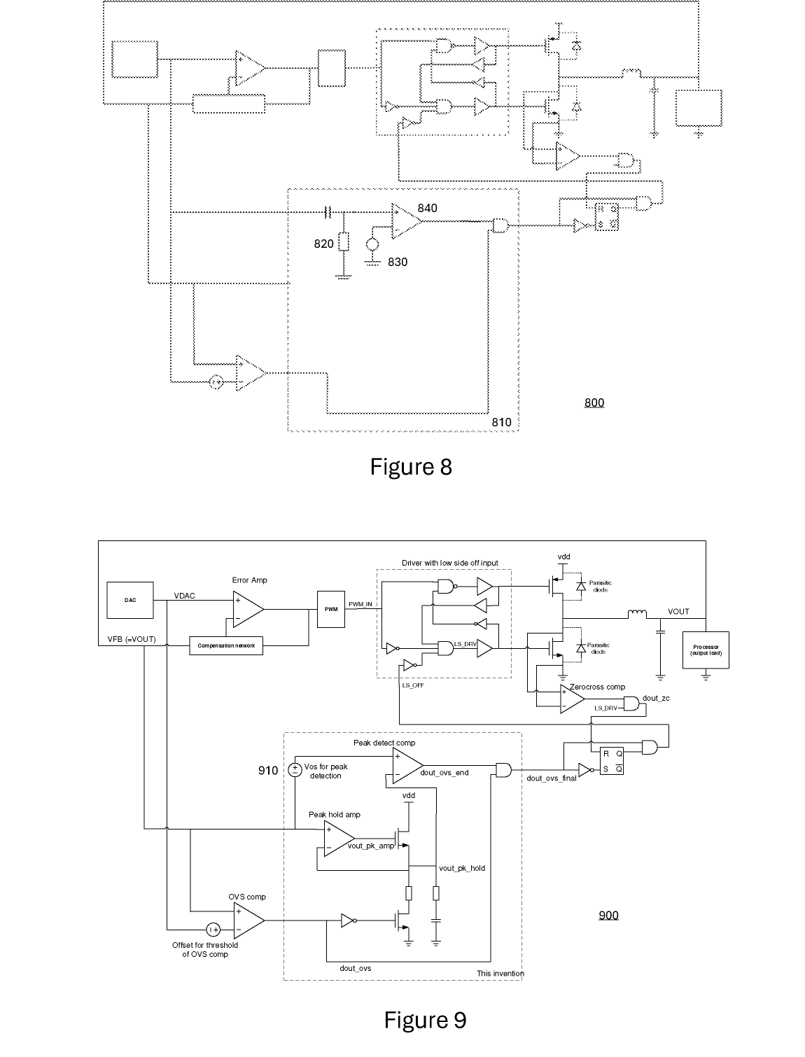

In an alternative example, the peak hold circuit may comprise instead a high-pass filter. This example is illustrated by FIG. 8.

In this example, the overshoot reduction circuit 810 may comprise a peak comparator device 840 configured to detect if the output voltage meets the second threshold; and a high-pass filter 820, 830 configured to detect a rate of change of the output voltage, wherein detecting the rate of change comprises detecting whether the output voltage is increasing, decreasing, or constant; wherein, if the rate of change of the output voltage is zero or negative, the second control signal is generated.

The high-pass filter may comprise a resistor 820 and an offset device 830. Alternatively, any configuration of high-pass filter may be used.

Another alternative example is described by reference to FIG. 9. In this example, ending the overshoot reduction function may comprise comparing, using the peak comparator device, an adjusted output voltage with a voltage output by the peak hold circuit and, if the adjusted output voltage decreases below the voltage output by the peak hold circuit 762, generating the second control signal. The adjusted output voltage may be a combination of the output voltage and an offset voltage provided by a voltage offset element of the overshoot reduction control circuit.

It should be understood that FIGS. 7 to 9 show are merely exemplary, and various alternative configurations and components are envisaged.

Various improvements and modifications can be made to the above without departing from the scope of the disclosure.

1. A method for operating a voltage regulator circuit for converting an input voltage into an output voltage comprising an input port for receiving an input voltage, an output port for providing an output voltage, an output voltage reference circuit configured to output a reference voltage, an overshoot detection device, an inductive device, and an overshoot reduction control circuit comprising a peak comparator device, the method comprising:
in response to detecting, by the overshoot detection device, that the output voltage exceeds a first threshold, generating a first control signal configured to turn on an overshoot reduction function configured to reduce the output voltage;
determining when to end the overshoot reduction function by:
detecting, using the peak comparator device if the output voltage crosses a second threshold and;
if the output voltage is detected to have crossed the second threshold, generating a second control signal configured to control the overshoot protection function to end.

2. The method of claim 1, wherein the second threshold corresponds to a value of the output voltage at which a rate of change of the output voltage is zero or negative.

3. The method of claim 1, wherein the first threshold is a voltage value that when exceeded by the output voltage indicates that the output voltage is greater than a target regulation voltage of the voltage regulator circuit.

4. The method of claim 1, wherein ending the overshoot reduction function comprises:
comparing, using the peak comparator device, the reference voltage and a voltage output by a peak hold circuit of the overshoot reduction control circuit; and
if the voltage output by the peak hold circuit decreases below the voltage of the reference circuit, generating the second control signal.

5. The method of claim 1, wherein ending the overshoot reduction function comprises:
comparing, using the peak comparator device, an adjusted output voltage with a voltage output by a peak hold circuit of the overshoot reduction control circuit; and
if the adjusted output voltage decreases below the voltage output by the peak hold circuit, generating the second control signal;
wherein the adjusted output voltage is a combination of the output voltage and an offset voltage provided by a voltage offset element.

6. The method of claim 4, wherein the second control signal is a combination of a third control signal and a fourth control signal;
wherein the third control signal is indicative of a difference between the reference voltage and the voltage output by the peak hold circuit; and
wherein the fourth control signal is the voltage output by the peak hold circuit, wherein the voltage output by the peak hold circuit is indicative of a difference between the output voltage and the voltage across the capacitive device.

7. The method of claim 1, wherein the overshoot reduction function comprises:
lowering an increase in output voltage; and/or
maintaining a current amplitude for a period of time.

8. The method of claim 7, lowering the increase of the output voltage comprises:
increasing a voltage across an inductive device of the voltage regulator circuit such that a current of the inductive device is decreased.

9. The method of claim 1, wherein determining when to end the overshoot reduction function further comprises:
detecting if a current across the inductive device or a low-side switch of the voltage regulator circuit reaches a third threshold; and
if so, ending the overshoot reduction function.

10. The method of claim 9, wherein the third threshold is a value of zero.

11. A voltage regulator circuit for converting an input voltage into an output voltage, the voltage regulator circuit comprising:
an input port for receiving an input voltage;
an output port for providing an output voltage;
a reference circuit;
an overshoot comparator device;
an inductive device; and
an overshoot reduction control circuit comprising a peak comparator device and a peak hold circuit, wherein the overshoot reduction control circuit is configured to:
generate, in response to detecting, by the overshoot detection device, that the output voltage exceeds a first threshold, a first control signal configured to turn on an overshoot reduction function configured to reduce the output voltage;
determine when to end the overshoot reduction function by:
detecting, using the peak comparator device, if the output voltage crosses a second threshold and;
if the output voltage is detected to have crossed the second threshold, generating a second control signal configured to control the overshoot reduction function to end.

12. The voltage regulator circuit of claim 11, wherein the peak hold circuit comprises an amplifier device, and is configured to maintain a constant current amplitude for the voltage regulator circuit when the overshoot reduction function is triggered;
wherein the amplifier device is configured to receive a positive input from the output voltage and a negative input from the overshoot comparator device; and
wherein the peak comparator device is configured to receive a positive input from the reference circuit and a negative input from the amplifier device.

13. The voltage regulator circuit of claim 12, wherein the peak hold circuit further comprises:
a transistor device coupled with a first resistor, wherein the transistor device is configured to remove current sink capability and to realize peak hold circuit with a capacitive device;
a capacitive device;
a first resistor configured to maintain a voltage across the capacitive device when the output voltage is not detected to have exceeded the first threshold.

14. The voltage regulator circuit of claim 13, wherein ending the overshoot reduction function comprises:
comparing, using the peak comparator device, a voltage of the reference circuit to a voltage across the capacitive device of the peak hold circuit; and
if the voltage output by the peak hold circuit decreases below the reference voltage, generating the second control signal.

15. The voltage regulator circuit of claim 13, wherein ending the overshoot reduction function comprises:
comparing, using the peak comparator device, an adjusted output voltage with a voltage output by the peak hold circuit; and
if the adjusted output voltage decreases below the voltage output by the peak hold circuit, generating the second control signal;
wherein the adjusted output voltage is a combination of the output voltage and an offset voltage provided by a voltage offset element of the overshoot reduction control circuit.

16. The voltage regulator circuit of claim 14, wherein the second control signal is a combination of a third signal and a fourth signal;
wherein the third signal is indicative of a difference between the reference voltage and the voltage output by the peak hold circuit; and
wherein the fourth signal is the voltage output by the peak hold circuit, wherein the voltage output by the peak hold circuit is indicative of a difference between the output voltage and the voltage across the capacitive device.

17. The voltage regulator circuit of claim 12, wherein the second control signal causes the overshoot reduction circuit to turn off a low-side switch to end the overshoot reduction function.

18. The voltage regulator circuit of claim 12, wherein the first control signal causes the overshoot reduction circuit to:
turn off the first resistor, removing a current sink capability provided by the first resistor, wherein the current sink capability is configured to keep a peak voltage of the capacitive device of the peak hold circuit at a first voltage;
maintain the first voltage and, using the peak comparator device, determine when the voltage output by the peak hold circuit meets a fourth threshold.

19. The voltage regulator circuit of claim 12, wherein the fourth threshold represents a point at which the voltage output by the peak hold circuit decreases below the reference voltage.

20. The voltage regulator circuit of claim 11, wherein the overshoot reduction circuit comprises:
a peak comparator device configured to detect if the output voltage meets the second threshold; and
a high-pass filter configured to detect a rate of change of the output voltage, wherein detecting the rate of change comprises detecting whether the output voltage is increasing, decreasing, or constant;
wherein, if the rate of change of the output voltage is zero or negative, the second control signal is generated.
